(19) United States
(12) Patent Application Publication
(10) Pub. No.: US 2004/0234721 A1
(43) Pub. Date: Nov. 25, 2004

(54) System and method for coupling polypropylene to other materials and the resulting composition

(76) Inventors: Yaron Mayer, Jerusalem (IL); Al J.C. Baur, Kibbutz Ramat Hashofet (IL)

Correspondence Address: YARON MAYER, 21 AHAD HA'AM ST., JERUSALEM, 92151, IL

(21) Appl. No.: 10/849,150

(22) Filed: May 20, 2004

(30) Foreign Application Priority Data
May 21, 2003 (CA) 2,429,111

(51) Int. Cl. B32B 31/00

(52) U.S. Cl. 428/116; 264/274; 156/242; 156/244.24; 156/244.11; 156/245; 428/223

(57) ABSTRACT

Polypropylene is one of the most commonly used plastics in furniture and various structures (such as for example plastic warehouses) due to its cheap price, friendliness to the environment (in terms of degrading in a reasonable time when thrown away as waste), and good strength per weight factor. However, one of its biggest disadvantages is that like Teflon it is very inert, and therefore it is very hard to paint it after production or to connect other materials to it for example through chemical means, ultrasound, or with heat. Although it is possible to add various patterns or textures, such as for example wood-like patterns to the cast, and although is possible to add for example more colors without mixing them or with only partial mixing in order to get more than one color, such a mixing cannot be precisely controlled and cannot be made to fit with the texture, whereas for example wood texture would require proper color changes in correlation with the texture. The present invention solves the above problems preferably by manufacturing the Polypropylene (for example by appropriate casting or extrusion) with a texture that can easily connect mechanically to other materials preferably by small protrusions such as for example T shaped protrusions and/or other protrusions that preferably become wider at their ends and/or various grooves that preferably become wider in their deeper parts. This is preferably done in combination with various corrugated structures. The same or similar methods can be used also for example for connecting various materials to structures made out of Teflon or of other chemically inert materials which are hard to connect to.

### BACKGROUND OF THE INVENTION

1. Field of the Invention

The present invention relates to the plastics industry, and more specifically to a system and method for coupling Polypropylene to other materials in order to enable adding more conveniently various textures and/or colors to Polypropylene products, and the resulting composition.

2. Background

Polypropylene is one of the most commonly used plastics in furniture and various structures (such as for example plastic warehouses) due to its cheap price, friendliness to the environment (in terms of degrading in a reasonable time when thrown away as waste), and good strength per weight factor. However, one of its biggest disadvantages is that like Teflon it is very inert, and therefore it is very hard to paint it after production or to connect other materials to it for example through chemical means, ultrasound, or with heat. Therefore in Polypropylene the only painting is typically done by adding the paint pigments before casting the material into the desired shape, and typically it is cast with only one color and no special patterns or textures. Although it is possible to add various patterns or textures, such as for example wood-like patterns to the cast, and although is possible to add for example more colors without mixing them or with only partial mixing in order to get more than one color, such a mixing cannot be precisely controlled and cannot be made to fit with the texture, whereas for example wood texture would require proper color changes in correlation with the texture. Other plastic materials, such as for example Polyester, are much more convenient to work with in this regard and can easily be created with desired textures and colors, however Polyester is much more expensive than Polypropylene and is also much less strong. There have already been suggestions to add nano-particles to Polypropylene in order to improve its dyeablility, as described for example in http://www.ntcresearch.org/current/year10/Projects/C01-D20.htm, however various experiments and solving of problems are still needed for accomplishing that.

It would therefore be desirable to enable easy and cheap bonding between Polypropylene and other more convenient materials, such as for example Polyester or Melamine, so that much more surface colors, including optionally various textures, become easily and cheaply available.

### SUMMARY OF THE INVENTION

The present invention solves the above problems by enabling preferably easy, cheap and strong coupling between Polypropylene and other more convenient materials, such as for example Polyester or Melamine. This is preferably done by at least one of the following ways:

1. Manufacturing the Polypropylene (for example by appropriate casting or extrusion) with a texture that can easily connect mechanically to other materials preferably by small protrusions such as for example T shaped protrusions and/or other protrusions that preferably become wider at their ends and/or various grooves that preferably become wider in their deeper parts. This is preferably done in combination with various corrugated structures, as shown for example in FIGS. 1a-d, since the Polypropylene is typically manufactured in cell-like structures in order to improve strength per weight. This way for example Polyester (which is created by mixing two materials at relatively low temperatures, such as for example 70 degrees) and/or for example various glues such as for example epoxy or plastic glue or other materials can be easily formed as a cover, so that the protrusions and/or grooves become connectors like anchors. The added material or materials can for example be made to look like wood in terms of colors and/or texture or like other desired materials. If a glue is used this way, it can also be used to connect other materials, such as for example a Melamine sheet and/or for example a preferably thin sheet of wood, and/or other materials which imitate for example wood or imitate other desired substances, so that externally the product can look similar for example to wood particle board furniture or to actual wood, or for example to metal, or stone, etc. This way, if glue is used, preferably the glue connects mechanically to the Polypropylene and preferably chemically to the added material. The added material can be coupled for example directly to the glue, or for example some intermediate additional material is used, for example for increasing the strength.

2. Adding for example preferably fine-grain wood particles and/or wood dust and/or other convenient preferably fine-grained materials to the liquid Polypropylene before or during the casting or extrusion, so that the surface is mixed with the more convenient materials and various glues can react with these materials.

Of course, various combinations of the above and other variations can also be used. The same or similar methods can be used also for example for connecting various materials to structures made out of Teflon or of other chemically inert materials which are hard to connect to.

### BRIEF DESCRIPTION OF THE DRAWINGS

FIGS. 1a-e show a few preferable examples of using preferably corrugated structures of Polypropylene for creating the mechanical anchoring with the other target materials or with various glues.

FIGS. 2a-h show a few preferable examples of ways to cheaply manufacture the structures that enable the mechanical anchoring.

FIG. 3a-c show an example of an expanding plug that can have a stable grip for example in the wall of a hollow cell in the Polypropylene structure, for example when a screw is screwed into it.

### IMPORTANT CLARIFICATION AND GLOSSARY

Throughout the patent when possible variations or solutions are mentioned, it is also possible to use combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable subcombination. All these drawings are just exemplary diagrams. They should not be interpreted as literal positioning, shapes, angles, or sizes of the various elements.

### DETAILED DESCRIPTION OF THE PREFERRED EMBODIMENTS

All of the descriptions in this and other sections are intended to be illustrative examples and not limiting.

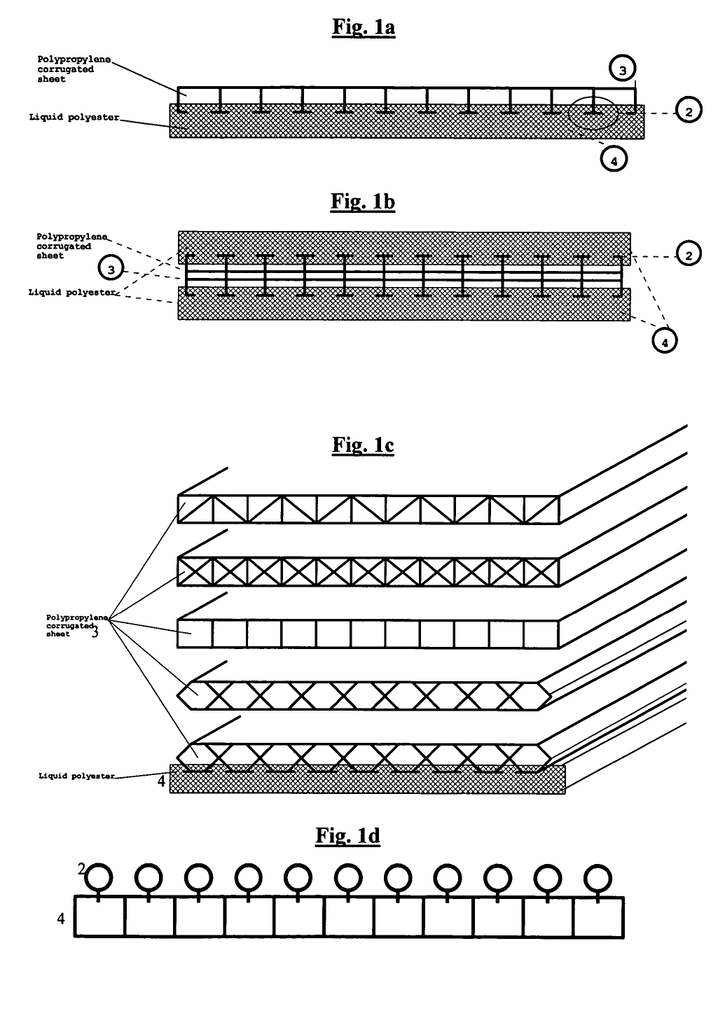

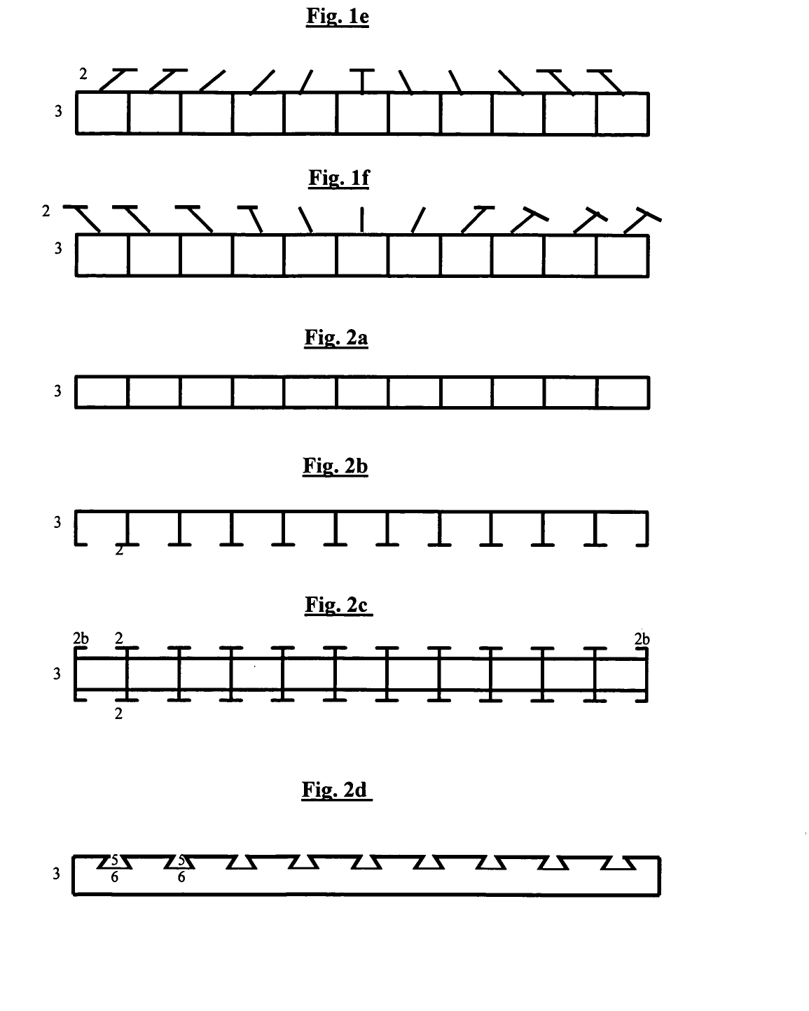

Referring to FIGS. 1a-e, we show a few preferable examples of using preferably corrugated structures of Polypropylene (3) for creating the mechanical anchoring with the other target materials or with various glues. The mechanical connection is preferably invisible on the outside. In FIGS. 1a&b the structure of the corrugated sheet is produced with T profiles (2) so that the wide part of the T is inside the added for example polyester or for example other liquid polymer or glue (4). After the liquid polymer or resin or polyester (4) is hardened, the T's (2) are stuck in the material (4) like anchors. FIG. 1b shows for example a corrugated sheet/plate (3) with polyester (or other material or materials) (4) coating on both sides. In this example the Polypropylene itself preferably has closed cell structures (3) in order to further increase its strength also independently of the added material (4). It should be noted that although the drawing shows the added material with a thickness larger than the Polypropylene structure, in reality it is preferably considerably thinner. In the above two examples, as can be seen, preferably there is some air gap between the Polypropylene and the added material, so that there can be for example differential thermal expansion between them if their thermal expansion coefficients are not the same, without causing stress in the materials. This is accomplished preferably by creating a fluid solution of the added material in an appropriate receptacle and inserting the solid Polypropylene structure into it preferably from above, only till the appropriate depth so that the gap exists between the two materials and preferably leaving the structure in that position until the added material solidifies. Another possible variation is to create it without the gap, in which case the Polypropylene structure is preferably lowered more deeply into the solution, or for example the fluid added material (4) can be itself for example added from above. The gap is not important if the added material has at least a similar thermal expansion coefficient, since most expansion of the added material will be anyway sideways, and thickness-wise expansion can occur anyway in the direction that is away from the border between the 2 materials, and the Polypropylene structure can expand anyway in various directions due to its cellular structure. In addition, preferably the leg of the T's is elastic enough to absorb the sideways expansion. Another possible variation (with or without the gap) is that the protrusions are for example pointing away from the center at similar angles or for example with variable angles so that protrusions that are more away from the center preferably bend away more, as shown for example in FIG. 1f, thus making them even more adapted to sideways expansion. Another possible variation is to create for example a hollow T structure (2) for example as shown in FIG. 1d (preferably with a thinner wall at the wide part of the T), or for example with a hollow wall even in the thin part (the leg) of the T, or other types of preferably widening hollow protrusions, so that sideways expansion of the added material can be absorbed for example by slight deformation of the hollow protrusions. Another possible variation is that if for example glue is used, the added material (which in this case is preferably added as already solid instead of in fluid form), is itself preferably constructed of a cellular structure or contains for example air bubbles, in order to further help absorb thermal expansion. FIG. 1c shows additional examples of forms of corrugated Polypropylene that can also be used by slight modification, for example by using an X-shaped corrugated structure where the edge has an on-off structure (created for example by cutting it on-off and/or by using appropriate extruder patterns), which is also another example of hollow structures at the border with the added material, like in FIG. 1d, so that stress caused by thermal expansion can be absorbed by the cellular structure. Another possible variation is to use for example non-elongated widening protrusions and/or non-elongated widening holes (in other words intermittent protrusions and/or grooves), but that is more difficult to produce, however various solutions for producing them are described below. If for example glue is used for connecting other materials to the Polypropylene then if grooves are used, they are preferably small enough to save glue, but are preferably not too small, since with too small grooves for example the surface tension in the glue can prevent entering the cavities (for example a groove can have a depth of for example 1-2 mm, and for example a width of 1-2 mm at the top and for example 3-4 mm at the bottom. Of course these measures are just examples for illustration). If protrusions are used, they are preferably short enough (for example 1-2 mm in height), so that not too much glue or added material is needed to cover them, but again preferably with a sufficient gap between their wider part and the Polypropylene surface so that there are no surface tension problems for entering this gap. Another possible variation is to use such smaller grooves and/or protrusions also if the added material, such as for example Polyester, is added without glue, so that a thinner layer of added material is needed, and, again, preferably they are not too small, so that there are no problems caused by the surface tension of the added material. Another possible variation is to create the protrusions and/or the grooves so that they are oriented in different directions—for example with changing angle of rotation according to their relative sideways position. If the protrusions for example all point towards the center, as shown for example in FIG. 1e, or for example away from the center, as shown for example in FIG. 1f, they can act as anchors even without widening, however preferably they contain also the widening or at least some of them contain it, in order to increase the strength of the connection. As explained above, preferably the protrusions are relatively small compared to the thickness of the Polypropylene, and they appear bigger in these illustrations only for better clarity of their outline. Of course, various combinations of the above and other variations can also be used.

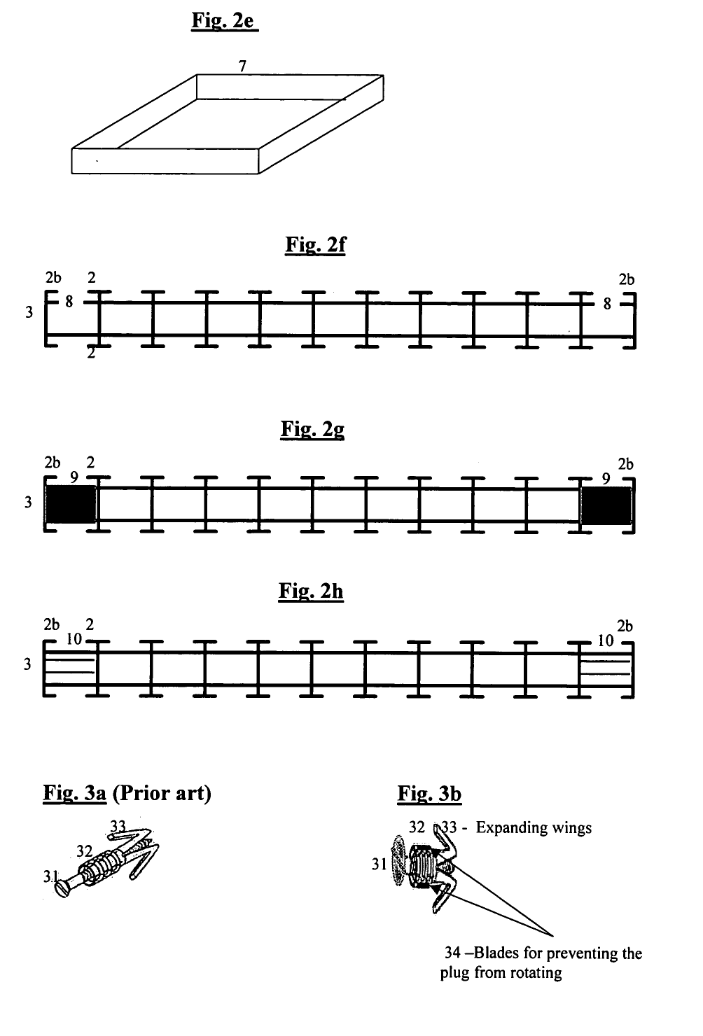

Referring to FIGS. 2a-h, we show a few preferable examples of ways to cheaply manufacture the structures that enable the mechanical anchoring. One possible way is for example to use existing extrusion machinery for producing the needed T's by making for example on-off cuts in a standard sheet shown in FIG. 2a to become the profile with T's shown in FIG. 2b (in this example the cuts are between the inner supports that connect between the walls). However, this can weaken the Polypropylene structure since the structural integrity becomes dependent on the added material, and it wastes the material of the cut parts, and also the T's will be typically too high. Another possible variation is to add for example various fibers, such as for example glass-fibers or carbon fibers, or even polyester-fibers (which are stronger than the Polyester itself) for example to the Polypropylene and/or to the polyester (or to the other added material or materials if other added material or materials are used), preferably by mixing them with the added material while the added material is in fluid form (and/or for example mixing them with Polypropylene the while the Polypropylene is in liquid form), in order to increase its strength and impact resistance. A more preferable variation is changing the extruder patterns (for example building a special T die and/or creating a special extruder) to create the structure shown for example in FIG. 2c, which is a stronger structure. In this example the structure is designed for 2-sided coating, which is useful for example if the resulting structure is sold as sheets. On the other hand, if for example it is manufactured as furniture, preferably typically only the external side is coated, so the T's (or other protrusions) are needed on only one side. FIG. 2d shows for example a structure of preferably small widening grooves (5) instead of protrusions, which is preferably created by appropriate extruder mouth (slit) shapes, which has the advantage that less added material is needed for a given thickness (since it has to fill only the grooves instead of all the area surrounding the protrusions), thus saving for example in the amount of glue or the amount of Polyester (or other material) needed. Of course, it is also possible to use for example various patterns that combine grooves with protrusions, etc. However, there is still a disadvantage in all of the above shown extruded structures, since this creates structures where elongated protrusions or grooves prevent the added material from being removed away from the Polypropylene or moved sideways, but it can still be moved for example in the direction that the extruded structure moves during manufacture, in other words, it might still be able to slide away in the length direction. This can be solved for example by creating and using an improved extruder in which the slits that create the bottoms of the grooves (marked as 6 in the drawing) can for example move automatically preferably gradually up and down repeatedly during the extrusion, so that intermittently, for example every few centimeters, the depth of the elongated groove changes, thus in practice dividing each groove into separate cells, so that the lengthwise sliding of the added material is no longer possible. Another possible variation is to move instead or in addition for example sideways the slits that create the sides of the grooves, so that the result is grooves with variable positions and/or variable width. In other words, in these variations preferably at least some of the slits in the extruder that create the grooves can move automatically up and down and/or sideways and/or change their angle repeatedly during the extrusion, and/or for example some slits remain the same all the time but plastic is poured through them only at the right times, and/or for example the slits remain the same, but some other part or parts can for example move for example up or down or for example sideways intermittently and can for example intermittently change the shape of the still flexible material as it comes out of the extruder for example by applying pressure to it (This last variation has the advantage that a modular moving element can preferably be added to existing extruders without having to change the extruder itself, and also it is easier than making a movable slit, since the slit has to withstand huge pressure), so that intermittently the depth and/or the width and/or the position and/or orientation of the elongated groove can change, thus in practice dividing each groove or at least some of the grooves into separate cells or sections. Of course, all such automatic changes are preferably done by computer control. Another possible variation is to use for example similar moving slits or patterns, in order to create divisions in the elongated protrusions, for example by moving up and down and/or sideways at least some of the slits that create the height and/or the width of the protrusions and/or changing their angles, and/or for example moving elements that move for example up or down intermittently and can for example intermittently change the shape of the still flexible material as it comes out of the extruder, thus creating for example protrusions with varying height and/or varying position and/or varying width and/or varying orientation. The above variations can be preferably applied for example to all of the protrusions and/or grooves or to at least some of them. Another possible variation is for example to automatically close and open on and off repeatedly for example the slits that create the protrusions and/or grooves and/or close and open the supply of material to them and/or part of them, so that the protrusions and/or grooves themselves or some of them appear and disappear intermittently, or a part or parts of them appear and disappear intermittently. Another possible variation is to use a similar method also for grooves. On the other hand the contact pressure between the two material can prevent free sliding out anyway, even without inner divisions, and leaving the grooves or protrusions elongated without inner divisions has the advantage that it can help also with the thermal expansion. Another possible variation is to add preferably only one division in each groove or protrusion (or at least in some of them), preferably in the center, so that on the one hand it prevents sliding out, and on the other hand expansion can occur in the two directions away from that center. This central dividing element can be added automatically during the extrusion for example as described above, or for example added after the extrusion by another process, for example by automatically inserting for example a nail or other mechanical element preferably in the middle of each elongated protrusion or groove or in at least some of them. Of course, various combinations of the above and other variations can also be used.

If no gap is used between the Polypropylene and the added material then the connection is preferably naturally not visible from the outside because the surfaces of the Polypropylene and of the added material are coupled closely together. If a gap or glue is used, then preferably the polypropylene and the added material are closely coupled together at the edges. If this is produced by extrusion then preferably for each of the two sides there is a preferably vertical slit at the edge which creates a leg that closes the gap, for example like the half-T's at the edge (2b)—in FIG. 2c, and preferably the front and/or back side (in the direction of the extrusion) are closed for example by one or more special elongated slit that can move and/or open and close when needed (or for example this slit exists there all the time but the plastic is poured through it only at the right times), or they are closed for example by inserting also each of these two edges into the glue or into the added material and covering them with the added material and/or with some other material, and/or for example the front and/or back ends are closed for example by some moving element that presses them into a closed shape while the extruded material is still flexible. Another possible variation is to add for example a square frame (7) as shown in FIG. 2e, which covers the edges like a sleeve, so that preferably the frame comes in contact with the glue in at least two of the sides and the other sides help hold the frame in place even more firmly. If the structure is created by casting instead of extrusion, as described below, then all the edges can be simply created by the mold. Of course, if for example extrusion or casting is used for creating whole furniture or furniture parts instead of boards, then there are less problems for the edges. Another possible variation is to create the widening protrusions and/or widening grooves in the Polypropylene for example by casting instead of extrusion, for example by creating a mold with elongated grooves and/or protrusions, from which the hardened Polypropylene is for example afterwards slid out along the length of the structures, and in this case the inner division of the elongated structures into smaller cells or sections can be done for example by slide-able or moveable walls or elements in the mold which are for example raised while the Polypropylene is liquid and are retracted after the Polypropylene has solidified in order to enable sliding it out, or for example by some moving element which can apply pressure at various points while the material is still flexible, or for example by adding for example nails or screws or other elements afterwards, as mentioned above. Another possible variation is to use for example various moveable and/or rotate-able parts in the mold for creating the preferably widening grooves and/or protrusions, so that the relevant parts are moved or rotated in order to enable removing the material after the casting. However casting in this case is less preferable since it cannot create the inner cellular structure of the Polypropylene itself unless for example at least two structures are cast and then soldered together for example by heating their edges again. Another possible variation is for example to cast the desired protrusions and/or grooves in the added material (such as for example melamine) and then use the added material as the mold for casting the Polypropylene. In other words, the added material is preferably pre-cast or pre-extruded with the desired protrusions and/or grooves and then the added material is used as the mold for casting the Polypropylene. However this means that the added material preferably has a melting point higher than Polypropylene, and still creating these structures in the added material has the same problems. Of course, various combinations of the above and other variations can also be used.

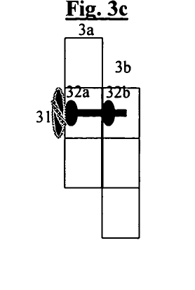

On the other hand, if the above described structures are created for example as boards instead of complete furniture or furniture parts, there is a problem that, unlike for example wood particle boards, it is more difficult to work with them flexibly on a modular basis, since arbitrarily cutting them can leave edges that contain open cells, and connecting such boards together is more complex than with wood, since they cannot be for example easily connected by nails or screws. Therefore, preferably these structures are planned in advance for specific uses, however this is not a big problem since also with wood particle boards users typically don't request boards to be arbitrarily cut but usually buy pre-designed kits that are already designed to fit together in a specific furniture. Typically plastic furniture that is composed of modular elements is connected by designing the various parts with various hooks or protrusions and various corresponding cavities in other parts, so that they are simply pushed and/or snap into position, so preferably these methods are also used for the above described structures. This means that preferably at least some of the parts that are not visible after the elements snap into position in the final furniture are preferably not covered by the other materials (such as for example polyester or Melamine), and preferably only visible parts or at least the top of them are covered by the other material or materials, and preferably only visible edges are covered also at the edges by the other material or materials. However, if for example the Melamine covered Polypropylene (or for example Polypropylene covered with thin sheets of wood) is intended to compete with wood furniture or wood particle board furniture, there is a problem that typically there is a larger available line of variable products for example with wood particle board furniture, whereas for example Polypropylene furniture typically come in a smaller number of available models, since typically special molds or extruders might be needed for each model. Therefore, another possible variation is for example to increase the modularity and the number of product choices available preferably by planning various types of parts so that the same parts can fit for example in more than one model of furniture. In other words, preferably at least some of the parts can preferably be used in more than one possible combination. Another possible variation is that extruders with various slits that can change position and/or orientation and/or be closed or opened dynamically (for example as described above) are used and/or molds with moving and/or rotating and/or flexibly changing parts (for example as described above) are used, so that the same extruders or molds can be set to produce different elements or parts as needed without the need to use a different extruder or mold for each part. Another possible variation is that for example in addition to or instead of having changeable or moveable elements in the extruder itself or in the mold itself there are for example other moving parts that can for example change the shape of the extruded or molded material while it is still flexible (for example as described above) and these elements can be used for example (preferably automatically, by computer control) for creating special protrusions and/or cavities at certain positions for example in automatically cut boards or parts (for example by pressing the still flexible material, for example as it comes out of the extruder or the mold, at certain points, or adding for example some additional Polypropylene material while the extruded material is still soft, and/or for example using hooks and/or clamps and/or other tools in order to pull out protrusions and/or for example bend parts at some points, etc.), so that for example standard shapes can be changed dynamically to a larger choice of shapes. Another possible variation is that for example every once in a while (for example every 10^{th} cell row, or any other convenient number, for example throughout the length of the cell or for example intermittently on and off even in the same row) the cell has one or more holes (8) in at least one side (preferably intermittently), so that the cell can be automatically also filled for example by the glue or other materials that are used for the cover, as shown for example in FIG. 2f. Another possible variation is that for example there are no holes and such special rows are for example automatically created so that they are filled with polypropylene (9) instead of being empty like the other cells, as shown in FIG. 2g, or for example such special rows contain multiple inner walls (10), as shown in FIG. 2h, so that it is easier for example to support screws in them. (Of course it is also possible for example to make all the cells with additional inner walls like this, but that would make the structure more expensive). These special rows and/or columns of filled cells and/or cells with additional inner walls are preferably marked with a special mark (for example some slit or protrusion, and/or for example some special color at the appropriate position on the element that covers the boards), so that the user can know that at such filled or special cells for example screws can be more easily used for connecting between two or more boards or parts. Another possible variation is to use expanding elements that can have a stable grip in the wall of the hollow cells. This can be done for example by using the structures shown in FIG. 3b. Of course, various combinations of the above and other variations can also be used.

Another problem is that if extrusion is used then typically there are rollers on top and/or on the bottom of the emerging board which have to apply pressure in order to pull it, however when creating for example T's or similar structures like for example in FIGS. 1e, 1f, 2b & 2c, the T's might be bent or distorted by the pressure of these rollers. Therefore preferably more rollers are used and/or rollers with more surface area, so that the pressure can be divided over a larger area. Another possible variation is to use for example a belt that goes for example around a number of such rollers, thus increasing even further the contact area with the extruded board or part. Another possible variation is to use for example one or more rollers with thin enough wheels on a hinge so that the wheels can enter the surface between the T's, however since the board typically may fluctuate sideways during the extrusion, preferably the entire hinge can also move freely sideways back and forth with the board if needed. Another possible variation is that the board is stabilized for example by adding guides at the two sides so that much less sideways fluctuations can occur during the extrusion. Of course, various combinations of the above and other variations can also be used.

Referring to FIGS. 3a-c, we show an example of an expanding plug that can have a stable grip for example in the wall of a hollow cell in the Polypropylene structure, for example when a screw is screwed into it (and/or for example some nail is pushed into it). As can be seen in FIG. 3a (which is a prior art plug that can be used for hollow room-walls), a typically plastic plug (32) with expanding wings (33) is inserted into the wall, so that during the insertion the wings (33) are folded to form a narrow pole, and when a screw (31) is screwed into the plug (32), the screw pushes the wings (33) apart, so that they expand in the inner hollow area beyond the external partition of the wall. However, such a plug is fit for use with walls where the external partition and the inner hollow area are much bigger than in a corrugated structure of a Polypropylene board. FIG. 32b shows a special plug adapted for use with such corrugated structures, in which preferably the ring of the plug (32) is much shorter (for example with a depth of about 1-3 mm), and preferably the plug and/or the wings are made of metal instead of plastic, so that it can be fit firmly within the external wall of the Polypropylene's corrugated structure. Preferably the ring of the plug (32) has screw lines on its internal circumference for the screw (31), and on its external circumference it has for example also screw lines, so that it is first screwed into a hole in the external wall of the Polypropylene's corrugated structure (preferably after a hole of the right size is drilled in the external wall of the cellular structure), and then the external screw (31) is screwed into the plug. Another possible variation is to use for example 1-4 or more preferably small, preferably metal, blades (34) at some distance from each other, protruding out of the external circumference, so that these blades help prevent the plug from rotating, and in this case preferably the plug is inserted into the Polypropylene's external wall by pressure, preferably after a hole of the right size is drilled in the external wall. In either case preferably the external edge of the plug is at least a little wider than the ring, in order to prevent the plug from falling into the hollow cell, and preferably the head of the screw is also wider. As in FIG. 3a, preferably the wings (33) are pressed together into a shape of a pole when the plug (32) is inserted, and when the screw (31) is inserted into the plug, the wings expand sideways, thus firmly securing the plug and the screw from both sides of the external wall. Of course this is just an example and for example the shape of the wings can also be different. The head of screw 31 is preferably sufficiently wider than the plug's ring, so as to make even more sure that the plug cannot fall into the internal hollow area. Preferably there are for example 2-4 or more such wings (preferably arranged in a circle, and preferably the inner part of the wing that is closer to the plug is at least partially concave like part of a circle), so that the grip is stable in multiple directions. Another possible variation is that similar wings are for example also on the outside (the side from which screw 31 is screwed), so that when expanded there is a supporting set of wings both on the inside and on the outside of the external wall. Another possible variation is that for example the screw (31) and the plug (32) are actually delivered together as one device (and for example the screw cannot be completely removed out of the plug), and so preferably first the plug (32) is screwed into the wall (with screw 31 already in it) and then the screw (31) is further screwed in and spreads the wings. Another possible variation is to use instead of the screw for example a nail or some special nail, which for preferably has for example changing width or has for example at least one protrusion or protrusions and/or groove or grooves in order to snap into its position after insertion. Of course, various combinations of the above and other variations can also be used.

This configuration can preferably be used for example for connecting between boards at 90 degrees with the help of typical angular connectors, so that for example each angular connector is connected by 2 screws to each of the two boards (altogether 4 screws for each angular connector in this example), and each of the screws preferably goes first through the appropriate leg of the angular connector and then through the above described plug. Of course in this example the size of the screw's head no longer needs to be bigger than the diameter of the plug but only needs to be bigger than the holes in the angular connector. On the other hand, if for example one board needs to be connected on top of another board, then the screw or other type of connector typically has to go through the entire thickness of at least the first board. In this case preferably the screw goes through the entire thickness of the part that is not visible and preferably the above described plug or a similar element is used so that the screw can end inside the 2^{nd} part. In this case of course the screw preferably goes though some metal ring before entering the first hole in the first board, in order to protect against the screw falling into the board or damaging the board. Another possible variation it to use a for example a similar plug with expanding wings also in the first board which the screw goes through, as shown for example in FIG. 3c, however this creates the problem that if for example the first plug (32a) also has internal screw lines, it might be problematic to continue rotating the screw (31) for the 2^{nd} plug (32b) after the screw has already reached the maximum point in the first plug. In order to solve this, in this variation preferably at least the first plug (32a) that the screw goes though has no internal screw lines and the screw is preferably inserted into it by pressure. Another possible variation is to use for example some nail or a special nail that snaps into position for both of the plugs, so that in this example even the 2^{nd} plug (32b) does not need internal screw lines. In this case of course preferably board (or part) 3a is preferably delivered to the consumer with the appropriate holes already drilled in both of its external walls, and board (or part) 3b is preferably delivered to the user with the appropriate holes already drilled in only its first external wall. Another possible variation is to use for example some similar plug or ring (preferably without expanding wings) also on the 2^{nd} wall of the first board (3a). Another possible variation that can be used in any of the above variations is that preferably the boards are delivered to the user with the plugs already inserted in them, so that the user only has to insert the appropriate screw or special nail, etc. in each plug (preferably in addition to snapping various preferably pre-designed protrusions and or cavities into position, etc.). Of course, various combinations of the above and other variations can also be used.

While the invention has been described with respect to a limited number of embodiments, it will be appreciated that many variations, modifications, expansions and other applications of the invention may be made which are included within the scope of the present invention, as would be obvious to those skilled in the art.

We claim:

1. A method for coupling between Polypropylene and other materials comprising the following steps:
a. Manufacturing a Polypropylene structure with a texture that contains at least one of protrusions and grooves that can act like anchors.
b. At least one of: 1. Pouring the desired other material and/or glue in a fluid form over the structure, and 2. Inserting the structure into the other material and/or into glue while said other material or glue is in fluid form.
c. If glue was used, connecting the added material to the glue.

2. The method of claim 1 wherein at least one of the following features exists:
a. The grooves become wider in their deeper parts.
b. The grooves have different orientations.
c. The protrusions become wider in their edges.
d. The protrusions have different orientations.
e. At least one of the protrusions and the grooves have orientations pointing at the center.
f. At least one of the protrusions and the grooves are elongated structures.
g. At least one of the protrusions and the grooves are elongated structures but at least some of them are divided into cells.
h. At least some of the protrusions and/or the grooves have only one central division in them, so that on the one hand it prevents sliding out, and on the other hand expansion can occur in the two directions away from that center.
i. The Polypropylene is based on corrugated structures, so as to increase its strength per weight factor by including internal cells.
j. The Polypropylene structure is created by at least one of casting and extrusion.
k. There is an air gap between the surfaces of the Polypropylene and the added material.
l. The surfaces of the Polypropylene and the added material touch each other without a specially designed air gap.
m. The protrusions have a hollow structure so that sideways expansion of the added material can be absorbed by slight deformation of the hollow structures.
n. If glue is used, the grooves and/or protrusions are small enough to save glue but are big enough so that surface tension in the glue does not prevent the glue from entering the cavities.
o. If the added material is added directly without glue, the grooves and/or protrusions are small enough to allow a thinner layer of added material, but are big enough so that surface tension in the added material does not prevent it from entering the cavities.
p. The mechanical connection between the Polypropylene and the added material is not visible on the outside.

3. The method of claim 1 wherein at least one of fine-grain wood particles, wood dust and other convenient fine-grained materials are added to the liquid Polypropylene before or during the casting or extrusion, so that the surface is mixed with the more convenient materials and various glues can react with these materials.

4. The method of claim 1 wherein there is some air gap between the Polypropylene and the added material, so that there can be differential thermal expansion between them if their thermal expansion coefficients are not the same, without causing stress in the materials.

5. The method of claim 4 wherein said air gap is accomplished by creating a fluid solution of the added material in an appropriate receptacle and inserting the solid Polypropylene structure into it only till the appropriate depth so that the gap exists between the two materials and leaving the structure in that position until the added material solidifies.

6. The method of claim 1 wherein the Polypropylene structures are created by extruding a double walled structure and cutting one of the walls in an on-off fashion in order to create the protrusions and/or grooves.

7. The system of claim 1 wherein fibers are added to the added material and/or to the Polypropylene, in order to increase its strength and impact resistance.

8. The method of claim 1 wherein the Polypropylene structures are created by using a special extruder with the appropriate patterns.

9. The method of claim 2 wherein at least some of the slits in the extruder that create the protrusions and/or the grooves can move automatically up and down and/or sideways repeatedly during the extrusion, so that intermittently the depth and/or the width and/or the position of the elongated protrusion and/or groove changes, thus in practice dividing each groove or at least some of the grooves into separate cells or sections.

10. The method of claim 2 wherein at least some of the slits that create the protrusions and/or the grooves in the extruder automatically close and open on and off repeatedly and/or the supply of material to them is opened and closed on and off, so that the protrusions themselves appear and disappear intermittently.

11. The method of claim 2 wherein some other part or parts apart from the extruder slits can move intermittently and can thus intermittently change the shape of the still flexible material as it comes out of the extruder.

12. The method of claim 2 wherein the widening protrusions and/or widening grooves in the Polypropylene are created by casting instead of extrusion, by creating a mold with elongated grooves and/or protrusions, from which the hardened Polypropylene is slid out along the length of the structures.

13. The method of claim 12 wherein the elongated structures are divided into smaller sections by slide-able or moveable elements in the mold which are raised while the Polypropylene is liquid and are retracted after the Polypropylene has solidified in order to enable sliding it out.

14. The method of claim 1 wherein the added material is pre-cast or pre-extruded with the desired protrusions and then the added material is used as the mold for casting the Polypropylene.

15. A composition of Polypropylene coupled to other materials wherein the following exists:
a. The Polypropylene structure has a texture that contains at least one of protrusions and grooves that can act like anchors.
b. The anchors are caught it at least one of: 1. The desired added material itself, and 2. A gluing material which is glued to the added material.

16. The composition of claim 15 wherein at least one of the following features exists:
a. The grooves become wider in their deeper parts.
b. The grooves have different orientations.
c. The protrusions become wider in their edges.
d. The protrusions have different orientations.
e. At least one of the protrusions and the grooves have orientations pointing at the center.
f. At least one of the protrusions and the grooves are elongated structures.
g. At least one of the protrusions and the grooves are elongated structures but at least some of them are divided into cells.
h. At least some of the protrusions and/or the grooves have only one central division in them, so that on the one hand it prevents sliding out, and on the other hand expansion can occur in the two directions away from that center.
i. The Polypropylene is based on corrugated structures, so as to increase its strength per weight factor by including internal cells.
j. The Polypropylene structure is created by at least one of casting and extrusion.
k. There is an air gap between the surfaces of the Polypropylene and the added material.
l. The surfaces of the Polypropylene and the added material touch each other without a specially designed air gap.
m. The protrusions have a hollow structure so that sideways expansion of the added material can be absorbed by slight deformation of the hollow structures.
n. If glue is used, the grooves and/or protrusions are small enough to save glue but are big enough so that surface tension in the glue does not prevent the glue from entering the cavities.
o. If the added material is added directly without glue, the grooves and/or protrusions are small enough to allow a thinner layer of added material, but are big enough so that surface tension in the added material does not prevent it from entering the cavities.
p. The mechanical connection between the Polypropylene and the added material is not visible on the outside.

17. The composition of claim 15 wherein at least one of the following features exists:
a. At least one of fine-grain wood particles, wood dust and other convenient fine-grained materials have been added to the liquid Polypropylene before or during the casting or extrusion, so that the surface is mixed with the more convenient materials and various glues can react with these materials.
b. The added material and/or to the Polypropylene has been strengthened with strengthening fibers.

18. An extruder wherein at least some elements can change intermittently during the extrusion, comprising at least one of:
a. A system wherein at least some of the slits that create grooves and/or protrusions in extruded Polypropylene can move automatically up and down and/or sideways repeatedly during the extrusion, so that intermittently the depth and/or height and/or the width and/or position of the grooves and/or protrusions changes, thus dividing the grooves and/or protrusions into separate cells or sections.
b. A system wherein at least some of the slits in the extruder that create protrusions in the extruded Polypropylene can automatically close and open on and off repeatedly and/or the supply of material to them is opened and closed on and off, so that the protrusions themselves appear and disappear intermittently.
c. A system wherein some part or parts other than the extruder's slits can move intermittently and can thus intermittently change the shape of the still flexible material as it comes out of the extruder.
d. A system wherein at least some slits can change position and/or orientation and/or be closed or opened dynamically, so that the same extruders can be set to produce different elements or parts as needed without the need to use a different extruder or mold for each part.
e. A system wherein other moving parts apart from the slits of the extruder can change the shape of the extruded material while it is still flexible, and these elements can be used for creating special protrusions and/or cavities at certain positions, so that standard shapes can be changed dynamically to a larger choice of shapes.

19. The method of claim 2 wherein the front and/or back side of the extruded material can be closed by at least one of:
a. By one or more special elongated slit that can move and/or open and close when needed.
b. By inserting also at least one of these two edges into the glue or into the added material and covering them with the added material and/or with some other material.
c. By a moving element that presses the front and/or back side into a closed shape while the extruded material is still flexible.
d. By adding a frame, which covers the edges like a sleeve, so that the frame comes in contact with the glue in at least two of the sides and the other sides help hold the frame it in place even more firmly.

20. The method of any claim 1 wherein in order to facilitate easy modular connecting between separate parts, at least one of the following is used:
a. Intermittently in some of the cell rows, throughout the row or in parts of it, the cell has one or more holes in at least one side, so that the cell can be automatically also filled by the glue or other materials that are used for the cover.
b. Intermittently some cell rows are automatically created so that they are filled with polypropylene instead of being empty like the other cells.
c. Intermittently some cell rows contain multiple inner walls so that it is easier to support screws in them.
d. Special rows and/or columns of filled cells and/or cells with additional inner walls are marked with a special mark, so that the user can know that such filled or special cells can be more easily used for connecting between two or more boards or parts.

21. The method of claim 1 wherein in order to facilitate easy modular connecting between separate parts, expanding elements that can have a stable grip in the wall of the hollow cells are used, and at least one of the following exists:
a. Said expanding elements are plugs with expending wings wherein the ring of the plug is short enough to fit in the external wall of the cellular structure.
b. Said expanding elements are plugs with expending wings, and the plug's ring has screw lines on its external circumference, so that it is first screwed into a hole in the external wall of the Polypropylene's corrugated structure, and then an external screw is screwed into the plug.
c. Said expanding elements are plugs with expending wings, and the plug's ring has at one or more blades at some distance from each other, protruding out of the external circumference, so that these blades help prevent the plug from rotating, and then an external screw is screwed into the plug.
d. Said expanding elements are plugs with expending wings, and the external edge of the plug is wider than the ring, in order to prevent the plug from falling into the hollow cell, and the wings are pressed together into a shape of a pole when the plug is inserted, and a the screw in inserted into the plug, the wings expand sideways, thus firmly securing the plug and the screw from both sides of the external wall.
e. Said expanding elements are plugs with expending wings, and the plug has similar wings also on the external side, so that when expanded there is a supporting set of wings both on the inside and on the outside of the external wall.
f. Said expanding elements are plugs with expending wings, and the plug comes with a connected screw inside it.
g. Said expanding elements are plugs with expending wings in which instead of a screw a nail is used for causing the wings to expand, or a special nail is used with changing width or with at least one protrusion or protrusions and/or groove or grooves in order to snap into its position after insertion.
